(19) United States
(12) Patent Application Publication
(10) Pub. No.: US 2025/0097626 A1
(43) Pub. Date: Mar. 20, 2025

(54) ORDERING AN AVATAR IN A VIRTUAL ENVIRONMENT

(71) Applicant: Orange, Issy-les-Moulineaux (FR)

(72) Inventors: Sylvain Leroux, CHATILLON CEDEX (FR); Thierry Gaillet, CHATILLON CEDEX (FR)

(21) Appl. No.: 18/887,974

(22) Filed: Sep. 17, 2024

(30) Foreign Application Priority Data
Sep. 18, 2023 (FR) 2309847

(51) Int. Cl. H04R 1/10

(52) U.S. Cl. CPC H04R 1/1083; H04R 1/1041; H04R 2460/01

(57) ABSTRACT

A noise filtering method is implemented by a terminal equipped with a microphone and with an audio output, the terminal connected to a communication network and used by a user equipped with a headset connected to the terminal. The method includes picking up, using the microphone, a first noise coming from a source, generating or not generating a second noise resulting from application of a filter to the first noise, rendering or not rendering the second noise to the user via the audio output and via the headset, and sending information relating to the first noise to at least another terminal connected to the network, this information used by at least the other terminal to filter the first noise.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The disclosed technology relates to the field of active noise filtering.

More specifically, the disclosed technology relates to the prediction and detection and filtering of noise nuisance, and to the pooling of alerts regarding such noise nuisance.

### Description of the Related Art

The densification of living spaces and the use of machines and communicating objects are contributing to the proliferation of noise nuisance: vehicle noise, portable electronic device ringtones, roadworks, etc.

Noise pollution may cause a variety of health problems: irritability, insomnia, depression, hearing problems or even hypertension and cardiovascular problems. In addition to its impact on health, noise pollution also has an economic and social impact, leading to accidents in the workplace and a general productivity deficit.

In addition to directly reducing noise emission sources, such as in particular reducing air and road traffic, limiting roadworks to restricted time slots, etc., there are various solutions for personally reducing the capturing of noise resulting from noise pollution: hide oneself away, wear earplugs or headphones, wear an active noise reduction device, deploy acoustic panels or even use noise reduction systems based on the diffusion of white noise.

However, these solutions have their own limitations:
in the case of hiding away, this is an individual solution that is often limited by circumstances,
fixed installations (acoustic walls or white noise diffusion installations) are often expensive and are always confined to their place of installation,
conventional filtering systems (earplugs, passive headphones) may, for their part, increase the risk of accidents by preventing their user from hearing important signals.

This is a general limitation of passive filtering solutions, it being understood that some noise may also be useful to certain agents/operators, while constituting a nuisance for other individuals in the vicinity.

This is the case for example with auditory feedback from cash registers in supermarkets. This auditory feedback, in the form of “beeps”, is useful for the cashier to know whether a product has been registered correctly, but also represents a nuisance for colleagues in the vicinity: on average, a cashier may register up to 700 items per hour, this corresponding to this number of “beeps” multiplied by the number of cash registers near each operator.

Conversely, other noise may constitute a nuisance for operators and be useful for people nearby. This is the case in particular for acoustic warning devices on emergency vehicles or construction vehicles: the sound level of a siren is approximately 110 dBm for a rate between 25 and 60 cycles per minute, which may make it difficult for the driver or their passengers to withstand on a daily basis. The same applies for construction machines equipped with reversing acoustic warning devices, which are able to emit audible signals of 87 dB, forcing workers to wear headphones or earplugs, thereby reducing the fluidity of their communication.

One solution to this problem is to use active systems. These are often wideband systems that broadcast an inverse sound to the sound that is picked up in order to attenuate it, keeping the amplitude of the signals but opposing their phases. Reference is then made to ANC: (“Active Noise Control”). The most sophisticated ANC devices, referred to as adaptive ANC devices, integrate detection of wanted sounds and unwanted noise, and then, after processing, are capable of broadcasting a sound in which unwanted noise has been filtered out. For this purpose, these filters implement in particular control functions based on the least squares method. However, these systems have limitations:
only low frequencies lower than 1 kHz are able to be filtered correctly, this being sufficient to attenuate engine or rolling noise for example, but not voices, shouting, sirens, certain grinding, etc.,
only noises of a periodic or regular nature are able to be filtered correctly, but not short or unusual noises,
in the event of incorrect setting or inappropriate use, they may generate noise on the signal through a phase offset.

Finally, there are hybrid solutions integrating ANC systems and proactive and targeted systems that adapt on the basis of configured or trained models that are detected in advance.

Other solutions integrate approaches that implement learning, for example using neural networks or the k-nearest neighbors method.

However, these solutions do not involve, a priori, an ability to determine the nuisance or the subjective degree of nuisance of each noise from the point of view of each user, for example the “beep” of a cash register, which is useful for the cash register operator but a nuisance for the operator of another cash register, the siren of an emergency vehicle, which is useful for an adjacent driver but a nuisance for the driver or a person far from the road.

In this regard, we will define a noise as a sound associated with a potential nuisance, the degree of which depends on the person picking up this sound. Depending on the person, one and the same noise may need to be filtered so that it is made inaudible/canceled out, that is to say completely filtered or attenuated or substituted (replaced by another sound).

### SUMMARY

One of the aims of the disclosed technology is to rectify at least one of the drawbacks highlighted by the abovementioned approaches by proposing a noise filtering method based on mechanisms for the detection, prediction and collaborative sharing of noise nuisance.

To this end, one subject of the disclosed technology relates to a noise filtering method implemented by a first terminal equipped with a microphone and with an audio output, said first terminal being connected to a communication network and used by a user equipped with a headset connected to said first terminal, said method comprising the following:
picking up a first noise coming from a source using said microphone,
generating or not generating a second noise resulting from application of a filter to the first noise,
rendering or not rendering the second noise to the user via the audio output and via said headset, characterized in that the method furthermore comprises the following:
sending information relating to the first noise to at least one second terminal, connected to the network, this information being able to be used by at least the second terminal to filter the first noise.

This sending of information relating to the first noise advantageously makes it possible to improve the filtering implemented by the second terminal or by any filtering device that receives this information via the second terminal. Receiving this information makes it possible in particular to anticipate the noise to be filtered and to parameterize in advance the generation or non-generation of a second noise resulting from application of a filter to the first noise.

This sending of information relating to the first noise also contributes to constituting the communication network as a collaborative noise filtering network, allowing an improvement in the overall noise filtering of all of the terminals connected to this network.

According to one particular embodiment of the noise filtering method, the first terminal picking up the first noise is preceded by a step of receiving information relating to the first noise from a third terminal connected to the communication network and in which this information is used by the first terminal to filter the first noise.

This embodiment has the advantage of enabling the first terminal to anticipate the generation or non-generation of a second noise, resulting from application of a filter to the first noise. This anticipation is made possible in particular by the fact that the transmission of the information relating to the noise, via the communication network, may be faster than the transmission of the noise through the air.

Receiving information relating to the first noise makes it possible in particular:
to ascertain the context in which the noise is emitted, or even its significance and/or its subjective degree of nuisance to the user of the first terminal, and thus to ascertain whether or not the first terminal should generate a second noise resulting from the application of a filter applied to the first noise,
where applicable, to better parameterize the generation of a second noise, for example by determining whether the first noise should be masked/canceled out, attenuated or substituted,
to limit computational resources by pooling certain processing operations related to generating the second noise.

This embodiment also contributes to consolidating and enriching the abovementioned collaborative noise filtering network, making it possible to optimize the improvement in the overall noise filtering of all of the terminals connected to this network.

According to another embodiment of the noise filtering method, said sending of information relating to said first noise to said at least second terminal is implemented only if said second terminal picks up said first noise.

This embodiment has the advantage of not needlessly invoking the first terminal, by implementing such a sending step, and the second terminal, by processing the received information, and therefore of limiting their electrical consumption while at the same time limiting the congestion of the communication network.

According to another embodiment, the second noise is generated in part on the basis of at least one filtering parameter specific to the first terminal.

This aspect of the disclosed technology offers the advantage of improving the generation or non-generation of a second noise, taking into account the fact that the degree of nuisance associated with a noise is subjective and varies from user to user.

For example, an emergency siren is a source of nuisance for the driver of an ambulance, but is useful for drivers in the vicinity of said ambulance, a cash register “beep” is a nuisance to people in the vicinity but constitutes a useful confirmation signal for the operator of said cash register.

According to another embodiment, the generation or non-generation of the second noise is followed by an evaluation of the filtering, this evaluation being used to improve said generation or non-generation of the second noise.

Evaluating the filtering advantageously makes it possible to refine the generation or non-generation of a second noise and contributes, where applicable, to improving the parameters used to generate said second noise resulting from the application of a filter to the first noise.

According to another embodiment, the noise filtering method includes sharing, with at least said second and/or third terminal, information relating to at least the first noise, said sharing being asynchronous with said pick-up of the first noise.

This embodiment advantageously enables terminals that have newly connected to the network to receive a set of data relating to at least one noise and to benefit from an upgrade of the information relating to the noise previously picked up by all of the other terminals connected to the network, thereby improving their overall ability to filter noise.

According to another embodiment, the generation of a new noise and/or the evaluation and/or the parameterization of the filtering are carried out by a server, and the generation of a new noise, the evaluation and the parameterization of the filtering are carried out on the basis of information relating to noise sent by terminals connected to the network.

According to another embodiment, the sent and/or received information relating to the noise includes any of the following data:
an audio signature of the first noise,
data quantifying the first noise,
contextual data relating to the source of the first noise and/or the periodicity of the emission of the first noise,
identification data of the at least first terminal that picked up the first noise,
a spatiotemporal position of the at least first terminal that picked up the first noise,
data relating to the generation or non-generation of the second noise by at least the first terminal,
evaluation data relating to the generation or non-generation of the second noise by at least the first terminal,
data relating to at least the user of said first terminal.

This information makes it possible to improve the quality and relevance of the filtering implemented by the terminals connected to the network, in various ways:
the reception of the audio signature of the first noise by a terminal allows said terminal to anticipate the generation of a secondary noise,
the context data make it possible to parameterize the generation or non-generation of a second noise and, where applicable, to parameterize the generation of this second noise in order to cancel out the first noise, to attenuate it or to substitute it, depending on the degree of nuisance that this noise covers with regard to the user of the terminal liable to pick up said first noise,
the spatiotemporal position of the first terminal makes it possible to construct a map of noise over time and to warn terminals entering a geographical region at a given time about noise that will potentially need to be filtered.

According to another embodiment:
said second terminal is a terminal similar to the first terminal or a server,
the third terminal is a terminal similar to the first terminal, a server or a connected microphone.

This embodiment offers the advantage of allowing the method to be implemented within a network of heterogeneous terminals, covering a larger number of implementation contexts:
an implementation between communicating terminals similar to the first terminal makes it possible to construct a peer-to-peer network in which each terminal takes on the role of client and server in turn. This type of architecture has the benefit of being robust and of limiting the centralization of information, which may present a risk in terms of personal data security,
an implementation between dissimilar terminals, for example between a terminal similar to the first terminal and a server, allows some data processing operations to be advantageously pooled on the server, thus optimizing the energy consumption of the communication network,
an implementation between dissimilar terminals, for example between a terminal similar to the first terminal and a connected microphone, makes it possible to integrate more varied terminals into the network and to generate and convey more comprehensive and more complete information relating to the noise.

The various embodiments or implementation features mentioned above may be added, independently or in combination with one another, to the noise filtering method as defined above.

The disclosed technology also targets a terminal equipped with a microphone and with an audio output, said terminal being connected to a communication network and used by a user equipped with a headset connected to said terminal, and in which said terminal is configured to:
pick up a first noise coming from a source using said microphone,
generate or not generate a second noise resulting from application of a filter to the first noise,
render or not render the second noise to the user via the audio output and via said headset, characterized in that the terminal is furthermore configured to implement the following:
send information relating to the first noise to at least one other terminal connected to the network, this information being able to be used by at least the other terminal to filter the first noise.

Such a terminal is in particular designed to implement the noise filtering method according to any one of the embodiments described above.

The disclosed technology also relates to a computer program comprising program code instructions for implementing the noise filtering method as mentioned above.

Such instructions may be stored durably in a non-transient memory medium implementing the noise filtering method according to the disclosed technology.

This program may use any programming language, and be in the form of source code, object code, or intermediate code between source code and object code, such as in a partially compiled form, or in any other desirable form.

The disclosed technology also targets a computer-readable recording medium or information medium comprising instructions of a computer program for implementing the noise filtering method as mentioned above.

The recording medium may be any entity or module capable of storing the program. For example, the medium may comprise a storage means, such as a ROM (“Read-Only Memory”), for example a CD-ROM (“Compact Disc Read-Only Memory”), a synthetic DNA (deoxyribonucleic acid) or a microelectronic circuit ROM, or else a magnetic recording means, for example a mobile medium, a hard drive or an SSD (“Solid-State Drive”).

Furthermore, the recording medium may be a transmissible medium such as an electrical or optical signal, which may be routed via an electrical or optical cable, by radio or by other means, such that the computer program that it contains is able to be executed remotely. The program according to the disclosed technology may in particular be downloaded from a network, for example an Internet network.

As an alternative, the recording medium may be an integrated circuit in which the program is incorporated, the circuit being adapted to execute or to be used in the execution of the abovementioned noise filtering method.

According to one exemplary embodiment, the present technique is implemented by way of software components and/or hardware components. With this in mind, the term “module” in this document may correspond either to a software component, to a hardware component or to a set of hardware and software components.

### BRIEF DESCRIPTION OF THE DRAWINGS

Other features and advantages will become apparent on reading particular embodiments of the disclosed technology, which are given by way of illustrative and non-limiting examples, and the appended drawings, in which:

FIG. 1 shows one example of an architecture in which the noise filtering method is implemented.

FIG. 2 illustrates the steps of the method according to one embodiment.

FIG. 3 illustrates the steps of the method according to another embodiment.

FIG. 4 illustrates the steps of the method according to another embodiment.

FIG. 5 illustrates the steps of the method according to another embodiment.

FIG. 6 shows one example of a noise filtering terminal, in one embodiment of the disclosed technology.

### DETAILED DESCRIPTION

Description of One Example of an Architecture in which the Noise Filtering Method is Implemented

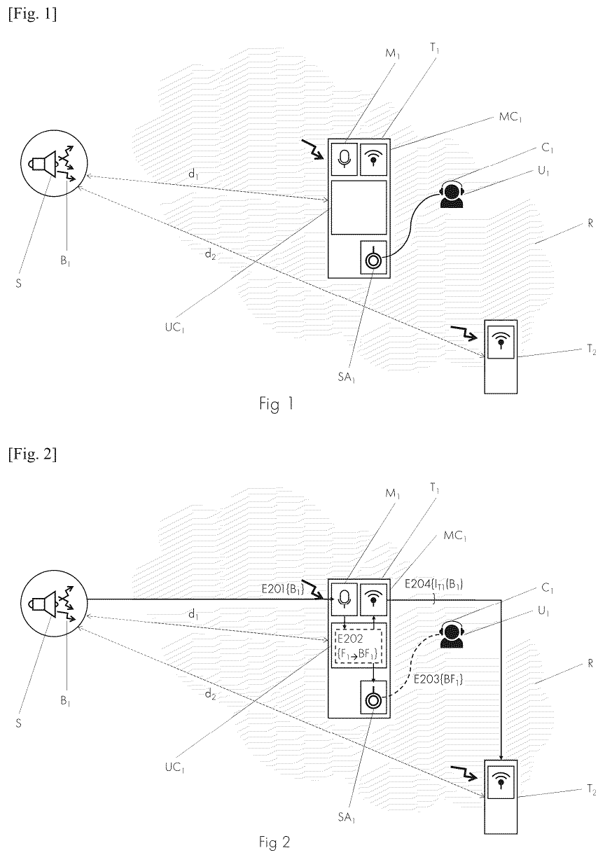

A description is given, with reference to FIG. 1, of one example of an architecture in which the noise filtering method is implemented. This architecture comprises:
a source S (for example an alarm or a cash register) emitting a noise B₁,
a terminal T₁ placed at a distance d₁ from the source S,
a terminal T₂ placed at a distance d₂ from the source S,
a user U₁ using the terminal T₁,
a communication network R.

The terminal T₁ is a communicating terminal, such as for example a smartphone or tablet, and is equipped with:
a microphone M₁,
an audio output SA₁,
a computing unit UC₁,
a communication module MC₁ enabling it to connect to the network R.

The user U₁ is equipped with an audio headset C₁ connected to the audio output SA₁ of the terminal T₁. Here, the term “audio headset” covers (open-back or closed-back) headband headphones, earpieces, in-ear headphones or any other listening device known to those skilled in the art.

According to some embodiments, the terminal T₁ is connected, via its audio output, to a non-personal listening device, such as a speaker or a sound panel.

According to some embodiments, the terminal T₁ and the audio headset C₁ are joined together and constitute a single terminal T₁, for example a connected headset or an augmented reality headset.

The terminal T₂ is connected to the network R and is placed at a distance d₂ from the source S.

According to the embodiments, the terminal T₂ is a communicating terminal similar to the terminal T₁ or any other communicating terminal, for example a server or a portable computer.

The communication network R to which the terminals T₁ and T₂ are connected constitutes a collaborative noise filtering network.

According to the embodiments, the network R takes the form of a peer-to-peer network in which each terminal alternately takes on a role of client and a role of server.

According to other embodiments, the network R takes the form of a centralized or semi-centralized network with specialized terminals specifically having a role of server, and others only a role of client.

The techniques used for pairing between terminals or for registering with one or more dedicated servers (not shown) of this network vary according to the embodiments. Such techniques are implemented for example following registration of the terminal within the network R or automatically on the basis of the geographical proximity between terminals or when a terminal enters a given geographical region.

According to the embodiments, the terminals associated with the communication network R, in particular the first and second terminals T₁, T₂, may exchange information such as:
(user and/or terminal) identity data,
geolocation data,
technical data specific to the terminal,
any other data processed by one of the communicating terminals associated with said communication network R,
etc.

These data may be exchanged using various techniques, such as, for example, as soon as a new terminal connects to the communication network R or at regular time intervals.

### Description of the Main Actions Implemented in the Noise Filtering Method

FIG. 2 shows the steps implemented by the noise filtering method in one particular embodiment of the disclosed technology, the method being implemented in an architecture similar to that described in FIG. 1.

In E201, the terminal T₁ picks up, via its microphone M₁, a first noise B₁ emitted by the source S. This noise is picked up after the sound wave of said noise has traveled the distance d₁ between the source S and the terminal T₁, that is to say

$$\frac{{d}_{1}}{speed of sound}$$

second(s).

In E202, the terminal T₁ generates, or does not generate, a second noise BF₁ resulting from application of a filter to the noise B₁.

The generation of this second noise forms part of the implementation of active noise control (ANC) techniques known to those skilled in the art.

Whether or not this second noise is generated depends on at least one characteristic of the noise and on at least one filtering parameter specific to the first terminal.

According to the conceivable embodiments, the characteristics of the noise are:
one or more objective characteristics of the first noise (intensity, wavelength, audio signature, etc.) and/or
one or more contextual characteristics (time of emission, nature of the emission source, significance/meaning, etc.) and/or
one or more subjective characteristics indicated on the terminal in relation to this noise or type of noise (subjective degree of nuisance, particular significance for the user, etc.),
etc.

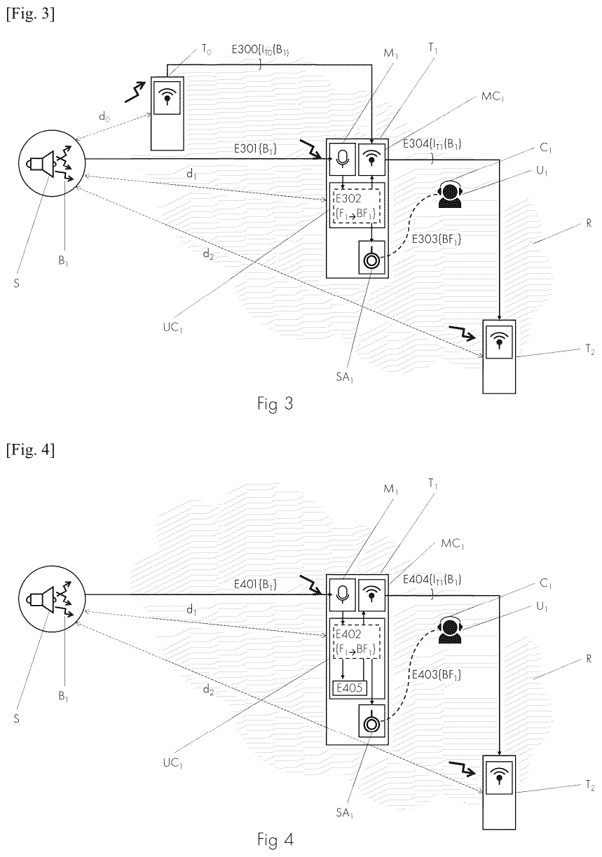

According to one particular embodiment, these characteristics may be collected on the basis of data that are already recorded in the first terminal or data received by third-party terminals. This embodiment is illustrated in particular in FIG. 3.

According to the conceivable embodiments, the filtering parameters specific to the first terminal may correspond to:
filtering noise greater than a certain number of decibels,
filtering noise that has not been pre-identified,
filtering ringing noise of all telephones other than that of the user,
filtering all noise indicated as being a nuisance by the user,
etc.

The filtering parameters specific to the terminal are kept as configuration data. According to the conceivable embodiments, these configuration data in relation to the filtering parameters are stored in the first terminal or in a server (not shown) connected to the communication network R.

If the first noise is identified as useful, that is to say it is associated with a zero degree of nuisance and the audio headset does not mask the first noise (for example in the case of open-back headphones or a sound barrier), no second noise is generated. Conversely, if the first noise is identified as useful and the audio headset blocks external noise (for example in the case of closed-back headphones or earplugs), then the second noise corresponds to an unfiltered retransmission of the first noise.

According to the conceivable embodiments, the generation of the second noise BF₁ varies depending on the one or more filtering parameters configured in the first terminal and depending on the ability of the audio equipment to passively mask the first noise B₁. Based on these elements, the second noise BF₁ may cancel out the first noise B₁, fade it by reducing its intensity, or substitute it for another noise/sound.

According to the conceivable embodiments, the generation or non-generation of a second noise is carried out directly by the computing unit UC₁ of the first terminal or within a server (not shown) connected to the communication network R.

In E203, the terminal T₁ renders the noise B₁ or BF₁ to the user via the audio output SA₁ and via the audio headset C₁.

In accordance with the principles of active noise control, the rendering of the second noise BF₁ is contiguous with the pick-up of the first noise B₁ by the microphone M₁, such that the superposition or substitution of the two sounds is substantially imperceptible to the user U₁.

If the generation or non-generation of a second noise has resulted in no second noise being generated, then this step is not implemented.

In E204, the terminal T₁ sends, to the terminal T₂, information I_{T1} (B₁) relating to the first noise B₁, so that this information is used by said terminal T₂ to be able to filter the noise B₁ as best possible.

According to the conceivable embodiments, the information relating to the noise B₁ may cover various types of data, such as for example:
the audio signature of the first noise B₁,
the audio signature of the second noise BF₁,
data quantifying the first noise B₁, such as sound frequency, duration, intensity or any other sound quantifications known to those skilled in the art,
contextual data relating to the source S and the periodicity of its emission, for example whether it is a connected terminal, a bell, an ambulance siren, these data, where applicable, possibly including identity, geographical position, network address (in the case of communicating equipments) or any other information relating to the source of the noise,
data relating to the identity and/or nature of the terminal that picked up the first noise B₁,
the spatiotemporal position of the first terminal when sending E204 the information relating to the noise B₁ that the first terminal picked up in E201,
where applicable, data as implemented by the terminal T₁ that generated the noise BF₁, relating to:
the configuration of the noise filtering parameters (for example the degree of nuisance of the noise B₁ from the point of view of the user U₁ of said terminal T₁, the significance of the noise B₁ from the point of view of the user (for example the ringing of their telephone, the “beeps” of their cash register, etc.)),
filtering of a noise B₁,
evaluation of filtering of a noise B₁,
data relating to the user U₁ of the terminal T₁ that picked up and filtered the noise B₁, this including for example the significance of the noise B₁ from the point of view of this user,
etc.

If the terminal T₁ is closer to the source S of the noise B₁ than the terminal T₂, such that d₁<d₂, and the information relating to the noise B₁ is transmitted to the terminal T₂ before the noise B₁ is picked up by the terminal T₂, then this information is used directly by the terminal T₂ to improve the filtering of the noise B₁ in advance of this noise being picked up by the terminal T₂. By way of example, the terminal T₂, knowing the sound signature of an upcoming nuisance noise, may generate a filtered noise BF₁ before said noise is picked up by said terminal T₂.

Otherwise, this information is used indirectly by the terminal T₂ to improve the noise filtering, for example in the case of iterations of the noise B₁ or by contributing to establishing a detailed map of the noise sources around the terminal T₂.

According to the conceivable embodiments, the terminal T₁ may send information relating to the noise B₁ to other terminals connected to the communication network R.

According to the conceivable embodiments, the information relating to the first noise B₁ is sent by the terminal T₁ to at least the terminal T₂, only if the terminal T₂ is able to pick up the noise B₁. Thus, for example, if the terminal T₁ identifies that the terminal T₂ is too far away for the noise B₁ to be able to be picked up by the latter terminal or by its user, the terminal T₁ does not send the information relating to the noise B₁ to the terminal T₂. Otherwise, the terminal T₁ sends this information to the terminal T₂.

### Description of the Steps of the Noise Filtering Method According to Another Embodiment

FIG. 3 shows the steps implemented by the noise filtering method according to another embodiment.

The method takes place in an architecture similar to that illustrated in FIG. 1. Such an architecture additionally comprises a communicating terminal T₀ placed at a distance do from the source S.

The terminal T₀ is also connected to the communication network R.

According to the conceivable embodiments, the terminal T₀ is a communicating terminal similar to the terminal T₁ or any other communicating terminal, for example a connected microphone or a server.

In E300, the terminal T₁ receives information I_{T0} (B₁) relating to the first noise B₁ from the terminal T₀, where the terminal T₀ is positioned so as to pick up the noise B₁ before the terminal T₁.

According to other embodiments, the terminal T₀ does not pick up the first noise B₁, but receives information relating to this noise from another terminal, not shown in FIG. 3, and sends this information to the terminal T₁ before the latter terminal picks up the noise B₁.

According to other embodiments, the terminal T₀ may be a server connected to a database such as a register of information relating to a noise or to a multitude of different noises, the server being configured to send all or some of this information to the terminal T₁.

According to other embodiments, the terminal T₀ may be coordinated with the source of the noise, for example by being physically associated with the source or by controlling it, and send, to the terminal T₁, information relating to the noise in advance of the noise B₁ being emitted.

The information relating to the noise B₁ may cover various types of data, and is similar to the description given thereof in FIG. 2. In this regard, it will not be described again.

Step E301 is similar to step E201 and will not be described again.

In E302, similarly to step E202 described in FIG. 2, the terminal T₁ generates, or does not generate, a second noise BF₁ resulting from application of a filter to the noise B₁. However, the information, received from the third terminal T₀, relating to the noise B₁ is also used to improve the filtering and the relevance of the filtering of the noise BF₁ that is generated or not generated.
Example 1: The terminal T₁ receives, from a communicating cash register, information relating to the noise emitted when an item is scanned, along with information relating to the identity of the user of the cash register. In this way, if the identity of the user of the terminal T₁ corresponds to that of the user of the cash register, the noise emitted thereby is filtered in a certain way (for example by attenuation or by substitution), whereas, if the identity of the user of the terminal T₁ does not correspond to that of the user of the cash register, the terminal T₁ filters the noise in another way (by attenuating it or by masking it/canceling it out completely).
Example 2: An ambulance driver U₁, equipped with a terminal T₁, is driving their emergency vehicle when they receive, from the on-board computer T₀, information corresponding to the audio signature of a siren B₁ of the ambulance, along with the GPS (“Global Positioning System”) position of said ambulance. In the step of generating the noise BF₁, the terminal T₁ compares its geolocation data with those of the source S and establishes that the user U₁ and the source are moving with one and the same vector and that the user U₁ is on board the ambulance. As a result, the terminal T₁, in E302, generates a noise BF₁ that masks the noise of the siren. Conversely, if the user U₁ does not have geolocation data that are similar over time to those of the source S, for example if this user is walking on a sidewalk near the ambulance, then the terminal T₁, in E302, generates a noise BF₁ that attenuates the noise B₁ of the siren so that the user U₁ is able nevertheless to be alerted about the proximity of an emergency vehicle, such as the ambulance in this example.
Example 3: Information relating to a noise identified as being periodic, such as the noise of a bell for example, enables the terminal T₁ to anticipate the emission of the noise by the source S, which terminal is activated only during the noise emission phases and goes into standby outside of these.

Step E303 is similar to step E203 and will not be described again.

In E304, similarly to step E204 of FIG. 2, the first terminal T₁ sends, to the terminal T₂, information I_{T1} (B₁) relating to the first noise B₁, so that this information is used by the terminal T₂ to be able to filter the noise B₁ as best possible.

According to other conceivable embodiments, the first terminal T₁ additionally sends, to the terminal T₂:
the information I_{T0}(B₁) received from the third terminal T₀,
and, where applicable, information relating to the first noise, received from any other terminal connected to the communication network R.

### Description of the Steps of the Noise Filtering Method According to Another Embodiment

FIG. 4 shows the steps implemented by the noise filtering method according to another embodiment, the method taking place in an architecture similar to that illustrated in FIG. 1.

Steps E401, E402, E403 and E404 are similar to steps E201, E202, E203 and E204 of FIG. 2, respectively. In this regard, they will not be described again.

In E405, the terminal T₁ evaluates the generation or non-generation of a second noise BF₁ resulting from application of a filter to the first noise B₁, in order to improve the next generations of second noises BF₁, along with the configuration of the parameters for generating second noises.

According to the conceivable embodiments, the evaluation of the filtering consists in directly interrogating the user U₁ via a form/request to evaluate the filtering of the noise B₁. This form may be filled in on the terminal T₁ if this is equipped with a dedicated user interface (touch screen, keyboard and screen, voice control, etc.) or from any other communicating terminal.

According to other conceivable embodiments, the evaluation of the filtering is automated and is based on analysis of behavioral data of the user captured elsewhere, for example via biometric data or data regarding the movement of the user's head. These data are captured by the first terminal T₁ or by a dedicated terminal known to those skilled in the art.

According to other conceivable embodiments, the evaluation of the filtering is automated and is based on analysis of the signal representative of the second noise BF₁ and on detection, in this signal, of parasitic signals indicating inadequate processing or based on any other processing of the signal implemented in the means for reinforcing active noise control techniques known to those skilled in the art.

According to the conceivable embodiments, the evaluation of the filtering may consist in automatically modifying certain configuration parameters relating to the selection of one or more filters and to the generation of the filtered noise.

According to the conceivable embodiments, the evaluation of the filtering implements various types of machine learning: incremental learning, supervised learning, unsupervised learning, reinforcement learning or any other form of learning known to those skilled in the art.

According to the conceivable embodiments, the filtering is evaluated after each implementation of the noise filtering method or periodically, for example every week, every month or after a predefined number of implementations of the noise filtering method.

### Description of the Steps of the Noise Filtering Method According to Another Embodiment

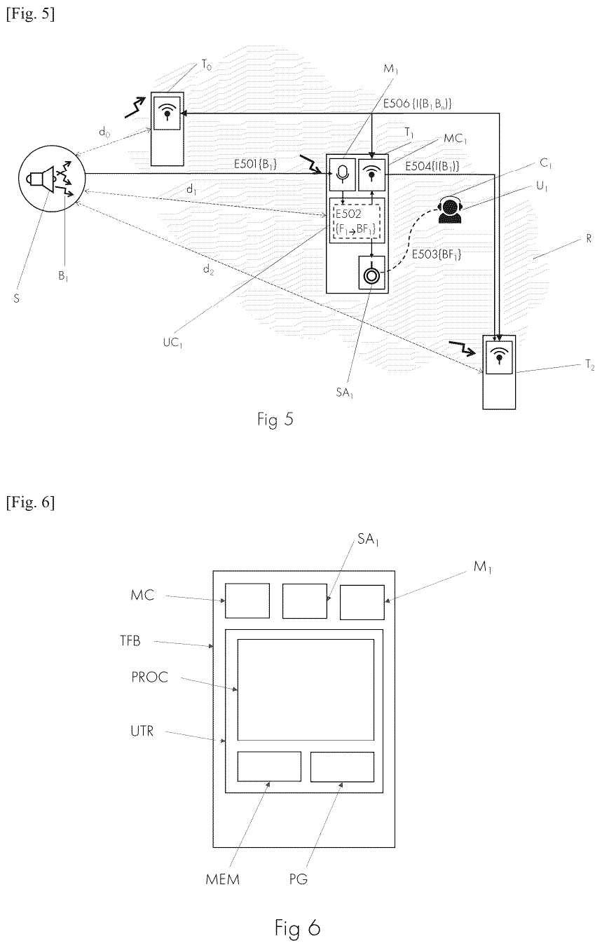

FIG. 5 shows the steps implemented by the noise filtering method according to another embodiment, the method taking place in an architecture similar to that illustrated in FIG. 1 or implemented in FIG. 3.

Steps E501, E502, E503 and E504 are similar to steps E201, E202, E203 and E204 of FIG. 2, respectively. In this regard, they will not be described again.

In E506, the terminal T₁ exchanges, that is to say sends and/or receives, information I(B₁,Bₙ) with the other terminals connected to the communication network R.

This information is of the same nature as the information relating to the noise B₁ described in the description of FIG. 2, and integrates at least the information I(B₁) relating to the noise B₁.

According to other conceivable embodiments, the information I(B₁,Bₙ) encompasses all of the generated and/or received information relating to noise known to the terminal T₁.

According to the conceivable embodiments, the information that is exchanged also includes data relating to the terminal sending these data, for example:
the one or more identifiers of the terminal, in particular a serial number or a name known on the network,
the nature of the terminal (smartphone, tablet, communicating microphone, computer, vehicle, etc.), technical data specific to its said nature (the list of noises it is able to generate, the sensitivity of its microphone, etc.),
its geographical position, where applicable its speed or its altitude,
its battery level,
all configuration parameters relating to the generation of filtered noise,
etc.

According to the conceivable embodiments, the information that is exchanged also includes data relating to the user of the terminal, for example:
the identity data of the user,
the role or the function of the user in a given organization,
all personal filter selection and filtered noise generation configuration parameters,
etc.

According to the conceivable embodiments, this step of exchanging information takes place when a terminal connects to the network R, at regular intervals or when terminals are placed close to one another or within a specific geographical region.

### Description of the Noise Filtering Terminal, in One Embodiment

FIG. 6 shows the simplified structure of a noise filtering terminal TFB according to one particular embodiment of the disclosed technology implemented in an architecture as illustrated in FIG. 1. According to the disclosed technology, the abovementioned terminals T₀, T₁ and T₂ correspond to the noise filtering terminal TFB.

Such a terminal comprises, according to the disclosed technology, a microphone M₁ and an audio output SA₁, a communication module MC for connecting to a communication network R and is used by a user equipped with a headset connected to said terminal TFB.

According to one particular embodiment of the disclosed technology, the actions carried out by the terminal TFB, in the context of implementing the noise filtering method of the disclosed technology, are implemented by instructions of a computer program PG. For this purpose, the terminal TFB has the conventional architecture of a computer and comprises in particular a memory MEM, a processing unit UTR, equipped for example with a processor PROC, and controlled by the computer program PG stored in memory MEM.

The computer program PG comprises instructions for implementing the steps of the noise filtering method, in particular the abovementioned actions:
picking up a first noise B₁ coming from a source S using said microphone M₁,
generating or not generating a second noise BF₁ resulting from application of a filter to the first noise B₁,
rendering or not rendering the second noise BF₁ to the user via the audio output SA₁ and via said headset,
sending information relating to the first noise B₁ to at least one other terminal connected to the network R, in which this information is used by at least this other terminal to filter the first noise B₁.

According to other embodiments, based on what is known as a cloud computing architecture, the processor PROC and the memory MEM may be associated with another terminal, different from the noise filtering terminal.

What is claimed is:

1. A noise filtering method implemented by a first terminal equipped with a microphone and with an audio output, said first terminal being connected to a communication network and used by a user equipped with a headset connected to said first terminal, said method comprising:
picking up a first noise coming from a source using said microphone,
selectively generating a second noise resulting from application of a filter to the first noise,
selectively rendering the second noise to the user via the audio output and via said headset, and
sending information relating to the first noise to at least one second terminal connected to the network, this information being able to be used by at least the second terminal to filter the first noise.

2. The method of claim 1, wherein the first terminal picking up the first noise is preceded by a step of receiving information relating to the first noise from a third terminal connected to the communication network, the received information being used by the first terminal to filter the first noise.

3. The method of claim 1, wherein the second noise is generated in part on the basis of at least one filtering parameter specific to the first terminal.

4. The method of claim 1, wherein the selective generation of the second noise is followed by an evaluation of the filtering, this evaluation being used to improve said selective generation of the second noise.

5. The method of claim 1, further including sharing, with at least said second and/or a third terminal, information relating to at least the first noise, said sharing being asynchronous with said picking up of the first noise.

6. The method of claim 1, wherein generation of a new noise and/or evaluation and/or parameterization of the filtering are carried out by a server, and wherein the generation of a new noise, the evaluation and the parameterization of the filtering are carried out on the basis of information relating to noise sent by terminals connected to the network.

7. The method of claim 1, wherein the information relating to the first noise comprises any of the following data:
an audio signature of the first noise,
data quantifying the first noise,
contextual data relating to a source of the first noise and/or the periodicity of emission of the first noise,
identification data of the at least first terminal that picked up the first noise,
a spatiotemporal position of the at least first terminal that picked up the first noise,
data relating to the selective generation of the second noise by at least the first terminal,
evaluation data relating to the selective generation of the second noise by at least the first terminal, and
data relating to at least the user of said first terminal.

8. The method of claim 1, wherein said sending of information relating to said first noise to said at least second terminal is implemented only if said second terminal picks up said first noise.

9. A terminal equipped with a microphone and with an audio output, said terminal being connected to a communication network and used by a user equipped with a headset connected to said terminal, said terminal configured to:
pick up, using said microphone, a first noise coming from a source,
selectively generate a second noise resulting from application of a filter to the first noise,
selectively render the second noise to the user via the audio output and via said headset, and
send information relating to the first noise to at least one other terminal connected to the network, this information being able to be used by at least the other terminal to filter the first noise.

10. A non-transitory, computer readable storage medium having stored thereon instructions which, when executed by a processor, cause the processor to implement the method of claim 1.

11. A computer comprising a processor and a memory, the memory having stored thereon instructions which, when executed by the processor, cause the computer to implement the method of claim 1
